(19) United States
(12) Patent Application Publication
(10) Pub. No.: US 2016/0267909 A1
(43) Pub. Date: Sep. 15, 2016

(54) VOICE RECOGNITION DEVICE FOR VEHICLE

(71) Applicant: TOYOTA JIDOSHA KABUSHIKI KAISHA, Toyota-shi, Aichi-ken (JP)

(72) Inventor: Kensuke HANAOKA, Setagaya-ku, Tokyo (JP)

(73) Assignee: TOYOTA JIDOSHA KABUSHIKI KAISHA, Toyota-shi, Aichi-ken (JP)

(21) Appl. No.: 15/032,474

(22) PCT Filed: Nov. 3, 2014
(86) PCT No.: PCT/IB2014/002453

§ 371 Date: Apr. 27, 2016

(30) Foreign Application Priority Data
Nov. 5, 2013 (JP) 2013-229331

(51) Int. Cl. G10L 15/22; G10L 15/065; G10L 15/02

(52) U.S. Cl. CPC G10L 15/22; G10L 15/02; G10L 15/065; G10L 2015/226; G10L 2015/223

(57) ABSTRACT

A voice recognition device includes a learning unit that learns a relationship between contents of the voice and information on the vehicle by storing recognized contents of the voice and the vehicle information at the time the voice is recognized in association with each other in a storage unit; a processing unit that calculates a recognition accuracy of the uttered voice each time an utterance is made; and an estimation unit that reads the vehicle information under a condition where the value calculated by the processing unit is less than a threshold. In a case where the vehicle information that has been read is in the storage unit, the contents of the voice associated with the vehicle information are estimated as contents of the voice. In a case where the estimation unit estimates contents of the voice, the control unit controls the vehicle on the basis of the estimated contents.

### BACKGROUND OF THE INVENTION

1. Field of the Invention

The invention relates to a voice recognition device for a vehicle that controls the operation of the vehicle on the basis of contents of the voice input by utterance.

2. Description of Related Art

A voice recognition device for a vehicle that controls the operation of the vehicle by recognizing the voice uttered by a vehicle occupant and transmitting a command which is set in association with the recognition result to a device installed on the vehicle has been suggested.

An example of such voice recognition device for a vehicle is available in which, for example, as described in Japanese Patent Application Publication No. 2008-26464 (JP2008-26464 A), the state of the road on which the vehicle travels is estimated according to the vehicle speed, and a command of interest is restricted according to the estimation result, thereby improving the voice recognition rate when controlling the vehicle operation.

However, with the device described hereinabove, when the vehicle is at a location where a sudden sound is generated, for example, at a railroad crossing, the voice input to the device can include a large noise and a sufficient voice recognition accuracy cannot be obtained. Thus, where the voice is difficult to recognize even when the command of interest is restricted according to the state of the road, the accuracy of vehicle operation control based on voice recognition decreases.

### SUMMARY OF THE INVENTION

The invention provides a voice recognition device for a vehicle that makes it possible to increase further the accuracy of vehicle operation control based on voice recognition.

A first aspect of the invention relates to a voice recognition device for a vehicle that is installed on the vehicle and equipped with a control unit that controls the vehicle on the basis of contents of the voice recognized from an utterance. The voice recognition device includes a learning unit that learns a relationship between the contents of the voice and information on the vehicle by storing the contents of the voice in a vehicle information storage unit in association with the vehicle information at the time the voice is recognized; a recognition accuracy calculation unit that calculates a recognition accuracy of the voice each time the voice recognition is performed; and an utterance estimation unit that reads the vehicle information in a case where the recognition accuracy is lower than a predetermined threshold and estimates that the contents of the voice associated with the vehicle information are contents of an uttered voice when the vehicle information that has been read is in the vehicle information storage unit, wherein, in a case where the contents of the voice are estimated by the utterance estimation unit, the control unit controls the vehicle on the basis of the estimated contents of the voice.

According to the abovementioned aspect, even when a sufficient voice recognition accuracy is not ensured because the uttered voice includes a large noise or the like, the vehicle information at the time the voice is recognized is learned in association with the recognized contents of the voice. As a result, the utterance contents are estimated according to the mode in which the driver operates the vehicle. Therefore, the control region such that becomes the so-called dead zone can be eliminated and the accuracy of vehicle operation control based on voice recognition can be further increased.

In the voice recognition device for a vehicle according to first aspect of the invention, under a condition where the recognition accuracy calculated by the recognition accuracy calculation unit is equal to or greater than the predetermined threshold, the learning unit may store the recognized contents of the voice and the vehicle information at this time in association with each other in the vehicle information storage unit

According to the abovementioned aspect, the vehicle information at the time the voice is recognized with good accuracy can be learned in association with the recognized contents of the voice. As a result, the utterance contents are estimated more accurately according to the mode in which the driver operates the vehicle. Therefore, the accuracy of vehicle operation control based on voice recognition can be further increased.

In the voice recognition device for a vehicle according to first aspect of the invention, under a condition where the recognition accuracy calculated by the recognition accuracy calculation unit is equal to or greater than the predetermined threshold, the learning unit may store the recognized contents of the voice and the vehicle information over a constant period of time before and after the condition is satisfied in association with each other in the vehicle information storage unit.

According to the abovementioned aspect, the vehicle information over a constant period of time before and after the voice is recognized with good accuracy is learned in association with the recognized voice contents. As a result, the utterance contents are estimated more accurately according to the series of modes in which the driver operates the vehicle over a constant period of time. Therefore, the accuracy of vehicle operation control based on voice recognition can be further increased.

In the voice recognition device for a vehicle according above aspect of the invention, the learning unit may prohibit the storage of the vehicle information in the vehicle information storage unit, under a condition where the recognition accuracy calculated by the recognition accuracy calculation unit is less than the predetermined threshold.

In the voice recognition device for a vehicle according to first aspect of the invention, the voice recognition device for a vehicle may further includes an utterance subject identification unit that identifies an utterance subject of the voice, wherein the learning unit may store the vehicle information in the vehicle information storage unit for each utterance subject identified by the utterance subject identification unit; and the utterance estimation unit may retrieve the utterance subject identified by the utterance subject identification unit from the vehicle information storage unit and may estimate the contents of the voice corresponding to the utterance subject, in a case where the uttered voice contents are estimated on the basis of the vehicle information.

According to the abovementioned aspect, the vehicle operation is controlled according to each operation mode of the vehicle by different drivers using the same vehicle. Therefore, general versatility of the vehicle operation control based on voice recognition can be increased.

A second aspect of the invention relates to a voice recognition device for a vehicle. The voice recognition device includes: a vehicle information storage unit that stores the contents of voice and vehicle information in association with each other; a recognition accuracy calculation unit that calculates a recognition accuracy of the uttered voice each time the voice recognition is performed; and an utterance estimation unit that reads the vehicle information when the recognition accuracy is lower than a predetermined threshold and estimates that the voice contents associated with the vehicle information are contents of an uttered voice when the vehicle information that has been read is in the vehicle information storage unit, wherein, when voice contents are estimated by the utterance estimation unit, the control unit controls the vehicle on the basis of the estimated voice contents.

According to the abovementioned aspect, even when a sufficient voice recognition accuracy is not ensured because the uttered voice includes a large noise or the like, the vehicle information at the time the voice is recognized is learned in association with the recognized contents of the voice. As a result, the utterance contents are estimated on the basis of the vehicle information stored in association with the vehicle information at this time. Therefore, the control region such that becomes the so-called dead zone can be eliminated and the accuracy of vehicle operation control based on voice recognition can be further increased.

In the voice recognition device for a vehicle according to second aspect of the invention, the voice recognition device for a vehicle may further includes an utterance subject identification unit that identifies an utterance subject of the voice, wherein the vehicle information storage unit may store the vehicle information for each utterance subject in association with the contents of the voice thereof, and the utterance estimation unit may retrieve the utterance subject identified by the utterance subject identification unit from the vehicle information storage unit and may estimate the contents of the voice corresponding to the utterance subject, in a case where the uttered voice contents are estimated on the basis of the vehicle information.

According to the abovementioned aspect, the vehicle operation is controlled under the control conditions that individually correspond to different drivers using the same vehicle. Therefore, general versatility of the vehicle operation control based on voice recognition can be increased.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram illustrating the schematic configuration of a vehicle using the voice recognition device for a vehicle of the first embodiment;

FIG. 2 is a schematic diagram illustrating an example of vehicle information stored in association with the utterance contents in the vehicle information storage unit of the first embodiment;

FIG. 3 is a flowchart illustrating the procedure of voice recognition processing executed by the voice recognition unit of the first embodiment;

FIG. 4 is a schematic diagram illustrating an example of vehicle information stored in association with the utterance contents in the vehicle information storage unit in the voice recognition device for a vehicle of the second embodiment; and

FIG. 5 is a schematic diagram illustrating the positional relationship of vehicle travel positions that are stored as vehicle information by the vehicle information storage unit of the second embodiment.

### DETAILED DESCRIPTION OF EMBODIMENTS

### First Embodiment

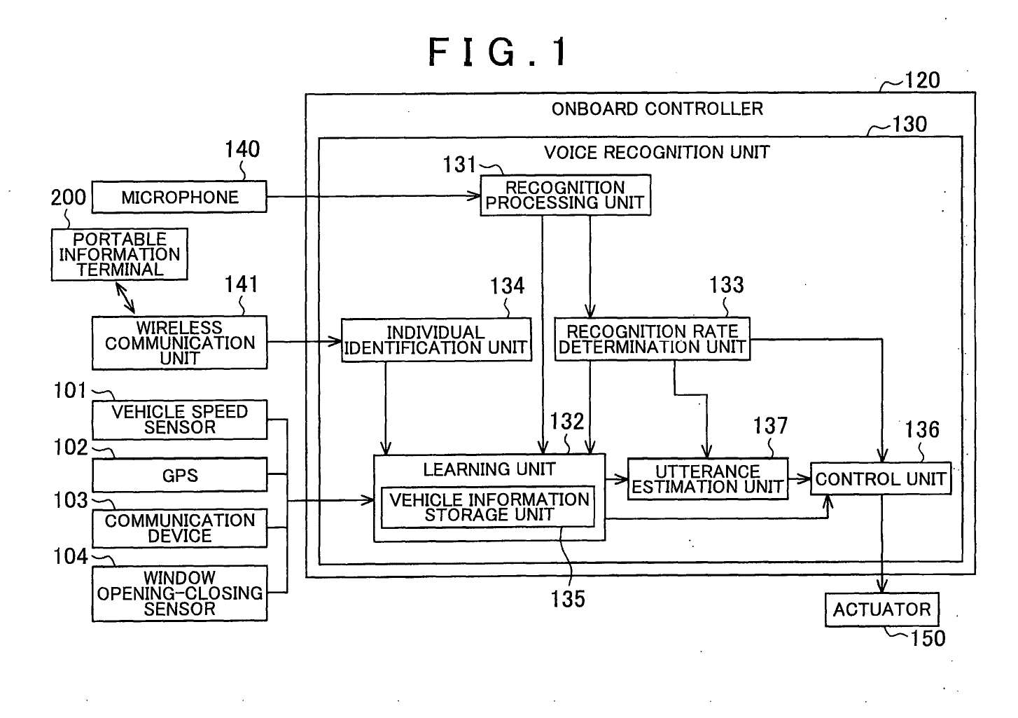

The first embodiment of the voice recognition device for a vehicle will be described hereinbelow with reference to the appended drawings. As depicted in FIG. 1, the vehicle using the voice recognition device for a vehicle of the present embodiment is provided with a vehicle speed sensor 101, a global positioning system (GPS) 102, a communication device 103, and a window opening-closing sensor 104, and those components are electrically connected to an onboard controller 120.

The vehicle speed sensor 101 detects the vehicle speed and outputs a signal corresponding to the detected vehicle speed to the onboard controller 120. The GPS 102 receives a GPS satellite signal for detecting the absolute position of the vehicle carrying the GPS 102. Further, the GPS 102 specifies the travel position of the vehicle on the basis of the received GPS satellite signal and outputs latitude-longitude information indicating the specified travel position to the onboard controller 120. The communication device 103, for example, acquires environmental information (external air temperature, weather, traffic congestion state, and the Eke) on the vehicle surroundings by wireless communication with a control center. The communication device 103 outputs the acquired environmental information to the onboard controller 120. The window opening-closing sensor 104 detects the opening-closing state of the vehicle window and outputs a signal corresponding to the detected opening-closing state to the onboard controller 120.

The onboard controller 120 of the present embodiment also includes a voice recognition unit 130 that recognizes a voice of the vehicle occupant. The voice recognition unit 130 has a recognition processing unit 131 that inputs the voice signal produced by the vehicle occupant through a microphone 140 provided at the vehicle.

The recognition processing unit 131, for example, divides the voice input from the microphone 140 into a plurality of sections having a predetermined time slot and matches, by dynamic programming (DP) matching, or the like, the characteristic vector of the voice contained in the divided sections with a characteristic vector of the voice pattern that has been prepared in advance. The recognition processing unit 131 also recognizes the voice pattern with the highest degree of similarity of the characteristic vector as the contents of the voice produced in the section and converts the recognized contents of the voice into text data. The recognition processing unit 131 also inputs the converted text data into a learning unit 132.

The recognition processing unit 131 also functions as a recognition accuracy calculation unit that calculates the recognition rate (recognition accuracy) of voice recognition in an utterance each time the utterance is made or each time voice recognition is performed. This calculation of the recognition rate is performed, for example, on the basis of a value obtained by adding up the degrees of similarity of the characteristic vector of the voice contained in one utterance and the characteristic vector of the voice converted into the text data for all of the sections including the utterance. The recognition processing unit 131 also inputs the calculated recognition rate of voice recognition into the recognition rate determination unit 133.

The recognition rate determination unit 133 determines whether or not the value of the recognition rate input from the recognition processing unit 131 is equal to or greater than a predetermined threshold X that has been set in advance. In this case, the predetermined threshold X is set as a reference value for determining as to whether or not the vehicle operation is adequately controlled on the basis of the contents of the voice recognized by the recognition processing unit 131. Further, when it is determined that the value of the recognition rate input from the recognition processing unit 131 is equal to or greater than the predetermined threshold X, the recognition rate determination unit 133 outputs a signal indicating the positive determination to the learning unit 132. Meanwhile, where it is determined that the value of the recognition rate input from the recognition processing unit 131 is less than the predetermined threshold X, the recognition rate determination unit 133 inputs a signal indicating the negative determination to the learning unit 132.

The voice recognition unit 130 of the present embodiment also has an individual identification unit 134 electrically connected to a wireless communication unit 141 provided at the vehicle. The wireless communication unit 141 inputs into the individual identification unit 134 information on the individual ID included in the information transmitted by wireless communication from a portable information terminal 200 owned by the vehicle occupant.

The individual identification unit 134 functions as an utterance subject identification unit that identifies a vehicle occupant as an utterance subject on the basis of information on the individual ID input from the wireless communication unit 141. Where a plurality of occupants is present in the vehicle and information on a plurality of individual ID is input through the wireless communication unit 141 from the portable information terminals 200 owned by the occupants, the individual identification unit 134 may output a list of the owners of the portable information terminals 200 identified by the individual ID to a monitor installed on the vehicle and display the list. In this case, the driver may set himself/herself as the utterance subject by selecting himself/herself from the list of owners displayed at the monitor.

Where the learning unit 132 inputs the signal indicating the positive determination from the recognition rate determination unit 133, the learning unit matches the text data input from the recognition processing unit 131 with a model of utterance contents. The learning unit 132 then identifies the matched utterance contents from the model as the contents of the utterance made by the vehicle occupant. In this case, the model is generated by applying a modeling method such as Bayesian networks or a decision tree to the text data of the utterance contents that have been prepared in advance.

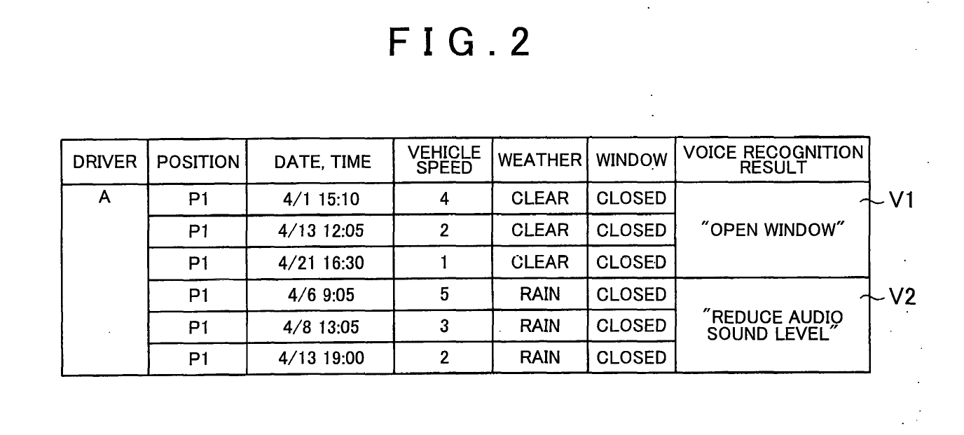

The learning unit 132 also stores the identified utterance contents in the vehicle information storage unit 135 in association with the vehicle information at the time the voice is recognized, for each vehicle driver identified by the individual identification unit 134. In this case, the vehicle information includes the travel position of the vehicle, date and time, vehicle speed, weather around the vehicle, opening-closing state of the vehicle windows, and the like. In the example illustrated by FIG. 2, a first utterance V1 (“OPEN A WINDOW”) and a second utterance V2 (“REDUCE AUDIO SOUND LEVEL”) are stored in the vehicle information storage unit 135 in association with the vehicle information at three points in time at which those utterances have been made. In this example, the driver “A” who is the utterance subject is the same, the travel position “P1” of the vehicle is also the same, and moreover, the windows of the vehicle are “CLOSED” at each point of time at which the utterances V1 and V2 have been identified. Meanwhile, when the first utterance V1 is identified, the weather around the vehicle is “CLEAR” at each point of time, whereas when the second utterance V2 is identified, the weather around the vehicle is “RAIN” at each point of time. Thus, in this example, when the vehicle is operated by the driver “A” so that the vehicle travels at a specific travel position “P1” in a state with closed windows, the contents of the utterance made by the driver “A” tends to be consistent with the weather around the vehicle at this time.

Where the recognition rate determination unit 133 determines that the value of the recognition rate input from the recognition processing unit 131 is equal to or greater than the predetermined threshold X, be recognition rate determination unit outputs a signal indicating the positive determination to the control unit 136. When the signal indicating the positive determination is input from the recognition rate determination unit 133, the control unit 136 reads from the learning unit 132 the information indicating the utterance contents identified by matching the model of utterance contents with the text data input by the learning unit 132 from, the recognition processing unit 131. The control unit 136 then controls the operation of an actuator 150 under the control conditions corresponding to the utterance contents read from the learning unit 132. In the present embodiment, the actuator 150 controls the operation of various onboard devices, such as the opening-closing operation of the vehicle windows, operation of audio devices installed on the vehicle, and ON/OFF operation of the turn signal of the vehicle.

Meanwhile, when the signal indicating the negative determination is input from the recognition rate determination unit 133, the learning unit 132 does not matches the model of utterance contents with the text data input from the recognition processing unit 131. Thus, when the signal indicating the negative determination is input from the recognition rate determination unit 133, the learning unit 132 prohibits the storage of the vehicle information at this time in the vehicle information storage unit 135 in association with the contents of the voice input from the microphone 140.

When the value of the recognition rate input from the recognition processing unit 131 is determined to be less than the predetermined threshold X, the recognition rate determination unit 133 also outputs the signal indicating the negative determined to the utterance estimation unit 137. When the signal indicating the negative determination is input from the recognition rate determination unit 133, the utterance estimation unit 137 acquires the vehicle information at this time into the learning unit 132 on the basis of the signals input from the vehicle speed sensor 101, GPS 102, communication device 103, and window opening-closing sensor 104 into the learning unit 132, and reads the acquired vehicle information from the learning unit 132. The utterance estimation unit 137 also reads the information stored in the vehicle information storage unit 135 from the learning unit 132. Then, the utterance estimation unit 137 retrieves the utterance subject identified by the individual identification unit 134 from among the information which has been read from the vehicle information storage unit 135, and extracts the information with the highest degree of similarity to the vehicle information, which has been read from the learning unit 132, from among the information obtained by the retrieval. The utterance estimation unit 137 then estimates the utterance contents, which corresponds to the extracted information, as the contents of the utterance made by the vehicle occupant. Then, the utterance estimation unit 137 outputs a signal indicating the estimated utterance contents to the control unit 136. The control unit 136 controls the operation of the actuator 150 under the control conditions corresponding to the estimation result on the utterance contents input from the utterance estimation unit 137.

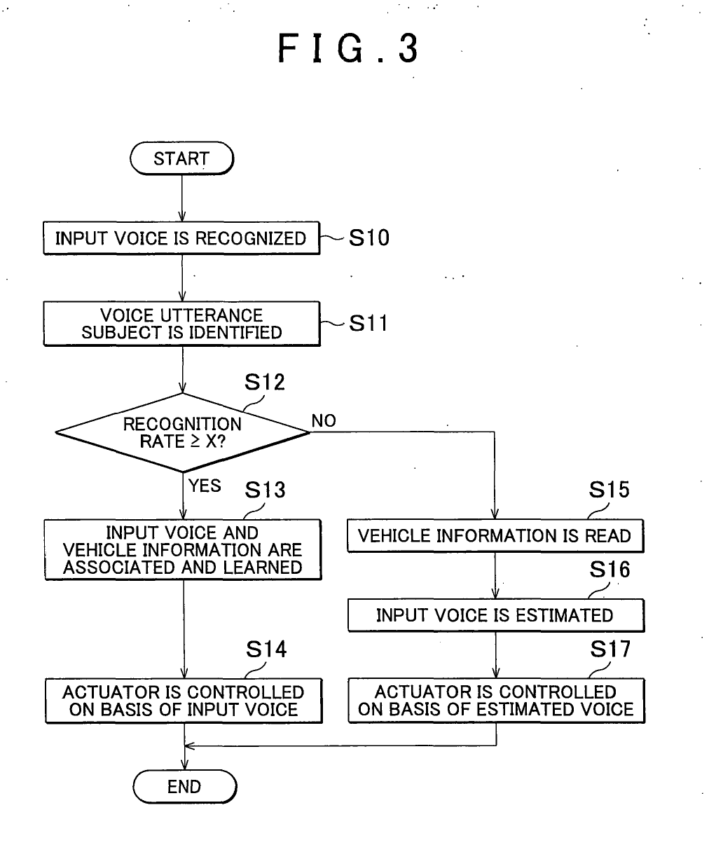

The schematic procedure of the voice recognition processing executed by the voice recognition unit 130 in the voice recognition device for a vehicle of the present embodiment will be explained hereinbelow with reference to the flowchart in FIG. 3. The voice recognition unit 130 executes the voice recognition processing depicted in the FIG. 3 each time a voice is input through the microphone 140. The recognition processing unit 131 recognizes the contents of the voice input through the microphone 140 (step S10).

Then, the individual identification unit 134 identifies the occupants of the vehicle on the basis of the information on the individual ID input from the wireless communication unit 141, and sets the voice utterance subject from among the identified occupants (step S11).

Then the recognition rate determination unit 133 reads from the recognition processing unit 131 the recognition rate of voice recognition, which has been calculated during the contents of the voice recognition performed by the recognition processing unit 131 in the preceding step S10, and determines whether or not the recognition rate which has been read is equal to or greater than the predetermined threshold X (step S12).

Where the recognition rate, which has been read by the recognition rate determination unit 133, is equal to or greater than the predetermined threshold X (step S12=YES), the learning unit 132 identifies the contents of the utterance made by the vehicle occupant by matching the contents of the voice recognized by the recognition processing unit 131 in the preceding step S10 with the model of utterance contents. The learning unit 132 also stores the identified utterance contents in association with the vehicle information at the time the voice is recognized in the vehicle information storage unit 135, for each utterance subject identified by the individual identification unit 134 in the preceding step S11 (step S13). The control unit 136 controls the operation of the actuator 150 under the control conditions corresponding to the utterance contents identified in the preceding step S13 (step S14).

Meanwhile, when the recognition rate which has been read from the recognition rate determination unit 133 is determined in the preceding step S12 to be less than the predetermined threshold X (step S12=NO), the utterance estimation unit 137 acquires the vehicle information at this time into the learning unit 132 and reads the acquired vehicle information from the learning unit 132 (step S15). The utterance estimation unit 137 then estimates the contents of the utterance made by the vehicle occupant on the basis of the vehicle information read from the learning unit 132 (step S16). The control unit 136 then controls the operation of the actuator 150 under the control conditions corresponding to the utterance contents estimated in the preceding step S16 (step S17).

For example, the vehicle travel position “P1”, the opening-closing state “CLOSED” of the vehicle window, and the weather “CLEAR” around the vehicle are taken as the vehicle information at the time the voice is recognized. In this case, in the example illustrated by FIG. 2, the utterance contents of “OPEN A WINDOW” are stored in association with this vehicle information in the vehicle information storage unit 135. Therefore, where the recognition rate which has been read by the recognition rate determination unit 133 is less than the predetermined threshold X under such conditions, the utterance estimation unit 137 estimates the utterance contents of “OPEN A WINDOW” as the contents of the utterance made by the vehicle occupant. The control unit 136 then controls the actuator 150 to perform the operation of opening the vehicle window in response to the utterance contents of “OPEN A WINDOW”, which are the utterance contents estimated by the utterance estimation unit 137.

In another case, the vehicle travel position is “P1” and the window opening-closing state of the vehicle is “CLOSED”, as in the above-described case, but the weather around the vehicle is “RAIN”, which is different from the above-described case, in the vehicle information at the time the voice is recognized. In this case, in the example depicted in FIG. 2, the utterance contents, of “REDUCE AUDIO SOUND LEVEL” is stored in association with such vehicle information in the vehicle information storage unit 135. Therefore, when the recognition rate, which has been read by the recognition rate determination unit 133, is less than the predetermined threshold X under such conditions, the utterance estimation unit 137 estimates the utterance contents of “REDUCE AUDIO SOUND LEVEL” as the contents of the utterance made by the vehicle occupant. The control unit 136 then performs the operation of reducing the audio sound level by controlling the actuator 150 in response to the utterance contents of “REDUCE AUDIO SOUND LEVEL”, which are the utterance contents estimated by the utterance estimation unit 137.

The operation of the voice recognition device, in particular, the voice recognition unit 130, of the present embodiment is explained below. In the present embodiment, when the recognition rate of the voice input through the microphone 140 is equal to or greater than the predetermined threshold X, the utterance contents are identified on the basis of the recognized contents of the voice. In this case, not only the operation of the actuator 150 is controlled under the control conditions corresponding to the identified utterance contents, but the identified utterance contents are also stored in association with the vehicle information at this time in the vehicle information storage unit 135.

Furthermore, where the recognition rate of the voice input through the microphone 140 is less than the predetermined threshold X, the information with the highest degree of similarity to the vehicle information at this time is retrieved from among the information stored in the vehicle information storage unit 135. The utterance contents corresponding to the retrieved information is estimated as the contents of the utterance made by the vehicle occupant, and the operation of the actuator 150 is controlled under the control conditions corresponding to the estimation result.

In this case, when the utterance contents are estimated, the contents of the voice input through the microphone 140 is not taken into account. Therefore, even when the recognition rate of the voice input through the microphone 140 has greatly decreased, where the information with a high similarity to the vehicle information at this time is stored in the vehicle information storage unit 135, the contents of the utterance made by the vehicle occupant can be estimated. Thus, where the voice input through the microphone 140 has been accurately recognized at least once in the past under the conditions same as or similar to the vehicle information at the time the present utterance is made, even when the recognition rate of the voice at the time the present utterance is made has decreased, the utterance contents can be accurately estimated.

In particular, in the present embodiment, after the utterance subject has been identified, the utterance contents are stored in association with the vehicle information at this time in the vehicle information storage unit 135 for each identified utterance subject. Therefore, even when the same vehicle is operated by different drivers, the operation of the actuator 150 can be controlled under the control conditions suitable for the vehicle operation mode of each driver.

Further, in the present embodiment, the utterance subject is identified on the basis of the information on the individual ID input by wireless communication from the portable information terminal 200 owned by the vehicle occupant. Therefore, when the utterance subject is identified, the contents of the voice input through the microphone 140 is not taken into account. Therefore, even when the recognition rate of the voice input through the microphone 140 has greatly decreased, the utterance subject can be identified.

As described hereinabove, the following effects can be obtained in accordance with the first embodiment. (1) Even when a sufficient voice recognition accuracy is not ensured because the uttered voice includes a large noise, the utterance contents are estimated on the basis of the contents of the voice stored in association with the vehicle information at the time the voice is recognized in the vehicle information storage unit 135. Therefore, the control region such that becomes the so-called dead zone can be eliminated and the accuracy of vehicle operation control based on voice recognition can be further increased.

(2) The vehicle information at the time the voice is recognized is stored in association with the recognized contents of the voice in the vehicle information storage unit 135. As a result, the utterance contents are estimated more accurately according to the mode in which the driver operates the vehicle. Therefore, the accuracy of vehicle operation control based on voice recognition can be further increased.

(3) The vehicle information at the time the voice recognition accuracy is equal to or greater than the predetermined threshold X and the voice is recognized with good accuracy is stored in association with the recognized contents of the voice in the vehicle information storage unit 135. As a result, the utterance contents are estimated more accurately according to the mode in which the driver operates the vehicle. Therefore, the accuracy of vehicle operation control based on voice recognition can be further increased.

(4) Where the voice recognition accuracy is less than the predetermined threshold X and the voice is not recognized with good accuracy, the vehicle information is not stored in the vehicle information storage unit 135. Therefore, the accuracy of vehicle operation control in the case in which a sufficient voice recognition accuracy is not ensured is maintained at a suitable level.

(5) The utterance estimation unit 137 retrieves the identified utterance subject from the information stored in the vehicle information storage unit 135 and estimates the uttered contents of the voice from among the contents of the voice corresponding to the retrieved utterance subject. As a result, the vehicle operation is controlled according to each mode of vehicle operation by different drivers using the same vehicle. Therefore, general versatility of the vehicle operation control based on voice recognition can be increased.

### Second Embodiment

The second embodiment of the voice recognition device for a vehicle will be described hereinbelow with reference to the appended drawings. In the second embodiment, the contents of vehicle information that are stored by the learning unit 132 in the vehicle information storage unit 135 are different from those of the first embodiment. Therefore, in the explanation below, the attention is focused on the features different from those of the first embodiment, and the redundant explanation of the features that are same as or correspond to those of the first embodiment is omitted.

The learning unit 132 of the present embodiment stores the utterance contents identified by matching the text data input from the recognition processing unit 131 with the model of utterance contents in the vehicle information storage unit 135 in association with the vehicle information over a constant period of time before and after the voice is recognized. In this case, the date and time included in the vehicle information have a constant time slot.

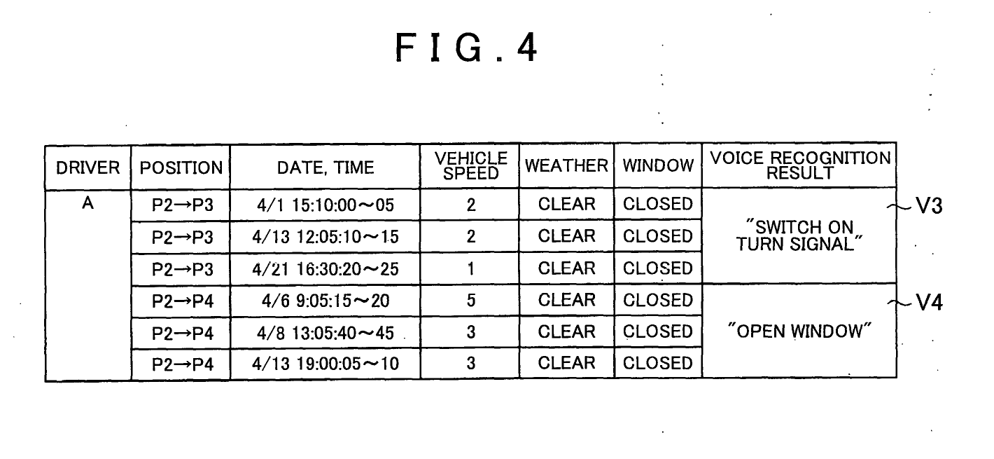

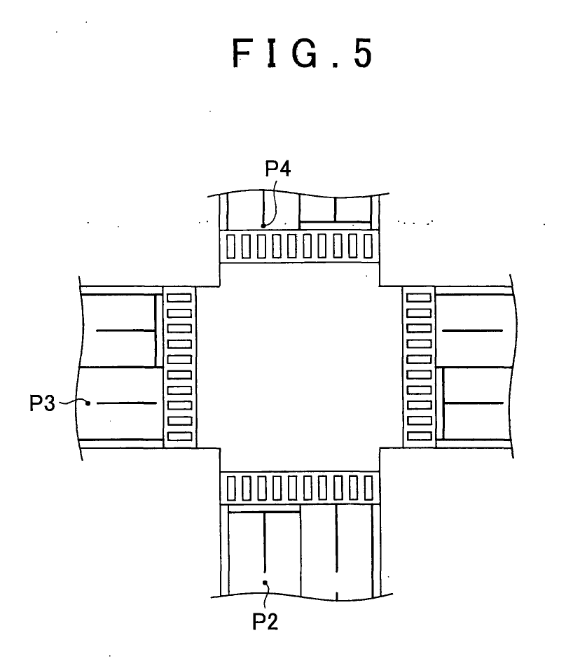

In the example depicted in FIG. 4, the learning unit 132 stores the utterance contents in the vehicle information storage unit 135 in association with the vehicle information for a period of 5 seconds before and after the utterance contents has been identified, and the date and time included in the vehicle information have a time slot of 5 seconds. In this example, the third utterance V3 (“SWITCH ON A TURN SIGNAL”) and the fourth utterance V4 (“OPEN A WINDOW”) are stored in the vehicle information storage unit 135 in association with the vehicle information at three dates/times at which those utterances have been made. The driver “A” who is the subject of the utterances is the same and the weather around the vehicle is “CLEAR” at each date/time at which the utterances V3 and V4 have been identified. Furthermore, the windows of the vehicle are “CLOSED” at each date/time. Meanwhile, when the third utterance V3 has been identified, the vehicle travel position is “MOVED FROM P2 TO P3”, whereas when the fourth utterance V4 has been identified, the vehicle travel position is “MOVED FROM P2 TO P4”. In this case, as depicted in FIG. 5, the “MOVEMENT FROM P2 TO P3” corresponds to the vehicle turning left at the intersection, whereas the “MOVEMENT FROM P2 TO P4” corresponds to the vehicle advancing straight through the intersection. Thus, in this example; when the vehicle is operated by the driver “A” to travel through a specific intersection when the weather is “CLEAR” in a state with closed windows, the contents of the utterance made by the driver “A” tends to be consistent with the vehicle travel mode at this intersection.

Accordingly, for example, the vehicle travel position “MOVED FROM P2 TO P3”, the weather “CLEAR” around the vehicle, and the vehicle window opening-closings state “CLOSED” are taken as the vehicle information at the time the voice is recognized. In this case, in the example depicted in FIG. 4, the utterance contents of “SWITCH ON A TURN SIGNAL” is stored in association with this vehicle information in the vehicle information storage unit 135. Therefore, when the recognition rate which has been read by the recognition rate determination unit 133 is less than the predetermined threshold X under such conditions, the utterance estimation unit 137 estimates the utterance contents of “SWITCH ON A TURN SIGNAL” as the contents of the utterance made by the vehicle occupant. The control unit 136 then performs the operation of switching on the left-turn signal by operating the actuator 150 in response to the utterance contents of “SWITCH ON A TURN SIGNAL” which are the utterance contents estimated by the utterance estimation unit 137.

In another case, the weather around the vehicle is “CLEAR” and the vehicle window closing-opening state is “CLOSED”, as in the above-described case, but the vehicle travel position is “MOVED FROM P2 TO P4”, which is different from the above-described case, in the vehicle information at the time the voice is recognized. In this case, in the example depicted in FIG. 4, the utterance contents of “OPEN A WINDOW” is stored in association with such vehicle information in the vehicle information storage unit 135. Therefore, when the recognition rate, which has been read by the recognition rate determination unit 133, is less than the predetermined threshold X under such conditions, the utterance estimation unit 137 estimates the utterance contents of “OPEN A WINDOW” as the contents of the utterance made by the vehicle occupant. The control unit 136 then performs the operation of opening the vehicle window by controlling the actuator 150 in response to the utterance contents of “OPEN A WINDOW”, which are the utterance contents estimated by the utterance estimation unit 137.

Therefore, according to the second embodiment, the following effects can be obtained in addition to the effects (1) to (5) of the first embodiment. (6) The vehicle information over a constant period of time before and after the time at which the voice has been accurately recognized is stored in association with the recognized contents of the voice in the vehicle information storage unit 135. As a result, the utterance contents are estimated more accurately according to the series of modes in which the driver operates the vehicle over a constant period of time. Therefore, the accuracy of vehicle operation control based on voice recognition can be further increased.

The above-described embodiments can be also implemented in the following forms. —In the embodiments, a method for identifying the utterance subject is not limited to that based on the information on the individual ID which is transmitted by wireless communication from the portable information terminal 200. For example, the utterance subject may be identified by recognizing the voiceprint of the voice input through the microphone 140.

In the embodiments, the learning unit 132 may store the vehicle information at the time the voice is recognized in the vehicle information storage unit 135 without discriminating the vehicle information between the utterance subjects. In this case, the voice recognition unit 130 may be not provided with the individual identification unit 134 for identifying the utterance subject of the voice.

In the embodiments, the learning unit 132 may store the recognized contents of the voice in association with the vehicle information at the time the voice is recognized in the vehicle information storage unit 135 even when the recognition rate which has been read by the recognition rate determination unit 133 is less than the predetermined threshold X.

In the embodiments, where the predetermined threshold X, which serves as a criterion for determining whether or not the control of vehicle operation is adequate on the basis of the contents of the voice recognized by the recognition processing unit 131, is taken as a first threshold, a value less than the first threshold may be set as a second threshold. In this case, where the value of the recognition rate input from the recognition processing unit 131 is equal to or greater than the second threshold and less than the first threshold, the utterance estimation unit 137 may estimate the utterance contents on the basis of the vehicle information at this time while taking into account the contents of the voice input through the microphone 140. Meanwhile, where the value of the recognition rate input from the recognition processing unit 131 is less than the second threshold, the utterance estimation unit 137 may estimate the utterance contents on the basis of the vehicle information at this time, without taking into account the contents of the voice input through the microphone 140.

In the embodiments, the recognition processing unit 131 may input the information on the voice waveform into the learning unit 132, without converting the recognized contents of the voice into text data. In this case, the learning unit 132 matches the information on the voice waveform input from the recognition processing unit 131 with the utterance contents model and identifies the matched utterance contents from the model as the contents of the utterance made by the vehicle occupant. In this case, the model includes the information on the voice waveform corresponding to the utterance contents that has been prepared in advance.

In the embodiments, the contents of the voice and vehicle information may be stored in advance in association with each other in the vehicle information storage unit 135 when the initial settings are made for the vehicle. In this case, when the voice input through the microphone 140 is recognized, the recognized contents of the voice may be associated with the vehicle information at this time and additionally stored in the vehicle information storage unit 135. Further, when the voice input through the microphone 140 is recognized, the recognized contents of the voice may be not stored in association with the vehicle information at this time in the vehicle information storage unit 135. In this case, the voice recognition unit 130 may be not provided with the learning unit 132. Further, in this case, the vehicle information storage unit 135 may store the vehicle information for each utterance subject, or may store the vehicle information without discriminating the vehicle information between the utterance subjects.

1. A voice recognition device for a vehicle which is installed on the vehicle and equipped with a control unit that controls the vehicle on the basis of contents of a voice recognized from an utterance, the voice recognition device comprising:
a learning unit that learns a relationship between the contents of a voice and information on the vehicle by storing the contents of the voice in a vehicle information storage unit in association with the vehicle information at the time the voice is recognized;
a recognition accuracy calculation unit that calculates a recognition accuracy of the voice each time the voice recognition is performed; and
an utterance estimation unit that reads the vehicle information in a case where the recognition accuracy is lower than a predetermined threshold and estimates that the contents of the voice associated with the vehicle information are contents of an uttered voice when the vehicle information that has been read is in the vehicle information storage unit, wherein
the control unit controls the vehicle on the basis of the contents of the voice in a case where the contents of the voice are estimated by the utterance estimation unit.

2. The voice recognition device for a vehicle according to claim 1, wherein, under a condition where the recognition accuracy calculated by the recognition accuracy calculation unit is equal to or greater than the predetermined threshold, the learning unit stores the recognized contents of the voice and the vehicle information at this time in association with each other in the vehicle information storage unit.

3. The voice recognition device for a vehicle according to claim 1, wherein,
under a condition where the recognition accuracy calculated by the recognition accuracy calculation unit is equal to or greater than the predetermined threshold, the learning unit stores the recognized contents of the voice and the vehicle information over a constant period of time before and after the condition is satisfied in association with each other in the vehicle information storage unit.

4. The voice recognition device for a vehicle according to claim 1, wherein
the learning unit prohibits the storage of the vehicle information in the vehicle information storage unit, under a condition where the recognition accuracy calculated by the recognition accuracy calculation unit is less than the predetermined threshold.

5. The voice recognition device for a vehicle according to claim 1, further comprising:
an utterance subject identification unit that identifies an utterance subject of the voice, wherein
the learning unit stores the vehicle information in the vehicle information storage unit for each utterance subject identified by the utterance subject identification unit; and
the utterance estimation unit retrieves the utterance subject identified by the utterance subject identification unit from the vehicle information storage unit and estimates the contents of the voice corresponding to the utterance subject, in a case where the uttered contents of the voice are estimated on the basis of the vehicle information.

6. A voice recognition device for a vehicle which is installed on the vehicle and equipped with a control unit that controls the vehicle on the basis of contents of a voice recognized from an utterance, the voice recognition device comprising:
a vehicle information storage unit that stores the contents of the voice and vehicle information in association with each other;
a recognition accuracy calculation unit that calculates a recognition accuracy of the uttered voice each time the voice recognition is performed; and
an utterance estimation unit that reads the vehicle information in a case where the recognition accuracy is lower than a predetermined threshold and estimates that the contents of the voice associated with the vehicle information are contents of an uttered voice when the vehicle information that has been read is in the vehicle information storage unit, wherein
in a case where the contents of the voice are estimated by the utterance estimation unit, the control unit controls the vehicle on the basis of the estimated contents of the voice.

7. The voice recognition device for a vehicle according to claim 6, further comprising:
an utterance subject identification unit that identifies an utterance subject of the voice, wherein
the vehicle information storage unit stores the vehicle information for each utterance subject in association with the contents of the voice thereof, and
the utterance estimation unit retrieves the utterance subject identified by the utterance subject identification unit from the vehicle information storage unit and estimates the contents of the voice corresponding to the utterance subject, in a case where the uttered voice contents are estimated on the basis of the vehicle information.
